(19) United States
(12) Patent Application Publication
(10) Pub. No.: US 2016/0194076 A1
(43) Pub. Date: Jul. 7, 2016

(54) LAYER FOR REDUCING FLUID RESISTANCE

(71) Applicant: CLIMATE INVEST B.V., St. Julian's (MT)

(72) Inventor: Jacobus Lambertus VAN MERKSTEIJN, Zermatt (CH)

(21) Appl. No.: 14/654,502

(22) PCT Filed: Dec. 19, 2013
(86) PCT No.: PCT/EP2013/077486

§ 371 Date: Jun. 19, 2015

(30) Foreign Application Priority Data
Dec. 21, 2012 (NL) 2010050
May 10, 2013 (NL) 2010787

(51) Int. Cl. B64C 21/10; B62D 35/00; B63B 1/34

(52) U.S. Cl. CPC B64C 21/10; B63B 1/34; B62D 35/00; B64C 2230/26

(57) ABSTRACT

The invention relates to a layer for reducing fluid resistance between an object and a fluid that are moving with a relative mutual speed, said layer comprising a substantially planar surface (12), said surface (12) comprising a pattern of outwardly extending elements (2), said elements (2) having an outer surface with a certain height with respect to the surface of the layer, said certain height increasing in a first direction in the plane of the layer, wherein the surface of the layer further comprises a plurality of recesses extending between the elements in a second direction in the plane of the layer, which recesses have a certain depth with respect to the surface of the layer.

The invention relates to a layer for reducing fluid resistance between an object and a fluid that are moving with a relative mutual speed. Said object may be an object moving through any stationary or moving fluid, or a fluid moving with respect to a stationary object. In moving objects, such as for instance a vehicle, for example an air plane, a car, or a boat, it is desirable to minimize the fluid friction, in particular air or water friction, since optimum performance can hereby be obtained in respect of the movement of the object. The performance of the moving object, such as a vehicle, for example an air plane, a car, or a boat, is influenced to a great extent by the fluid resistance. The fluid resistance depends for instance on the speed and the surface over which flow takes place. In moving fluids, such as for instance oil in a pipe, it is also desirable to minimize the fluid friction.

It is noted that in this application by fluid is meant any fluid, such as, but not limited thereto, any liquid, such as, but not limited thereto, water or oil, or any gas, such as, but not limited thereto, air, oxygen, nitrogen.

The state of the boundary layer of the fluid is also important for the fluid resistance. If the boundary layer is turbulent, the resistance will be less than if the boundary layer is laminar. In particular, the thickness of the turbulent boundary layer must remain more or less constant in order to have relatively low fluid resistance. In order to maintain the turbulent boundary layer at a constant thickness, it may be necessary to bring in or suck off turbulent fluid in or from the boundary layer.

It is now an object of the invention to provide a layer which can be arranged on an object with which the fluid resistance of the object with respect to a fluid can be reduced.

WO-A1-2007/017290 discloses a layer for reducing air resistance of a forward-moving object, which layer comprises a pattern of surfaces rising in a first direction and recesses running between the surfaces in a second direction at an angle to the first direction.

It is in particular an object of the invention to improve the layer disclosed in WO-A1-2007/017290.

This object is achieved with a layer which comprises a substantially planar surface, said surface comprising a pattern of outwardly extending elements, said elements having an outer surface with a certain height with respect to the surface of the layer, said certain height increasing in a first direction in the plane of the layer, wherein the surface of the layer further comprises a plurality of recesses extending between the elements in a second direction in the plane of the layer, which recesses have a certain depth with respect to the surface of the layer.

In accordance with the invention said layer comprises recesses having a certain depth with respect to the surface of the layer. In said recesses vortices are created that influence a main fluid flow flowing over said surface by bringing in or sucking off fluid, thereby maintaining a main flow with a turbulent boundary layer with a more or less constant thickness. The applicant has found that as a result of said recesses, vortices are created that efficiently influence the main flow.

Said first direction in which the elements extend differs from said second direction in which the recesses extend. The angle between the first direction and second direction may vary, as will be described later, but it is noted here that the angle is at least partly unequal to zero.

Said recesses may be located at a longitudinal end zone of said elements.

In use said layer is arranged on said object such that said main fluid flow flows in the first direction of the elements. Said recesses and therefore said vortices flow in a second direction. Said second direction varies over the length of the recesses, such that the angle differs from an entry end of the recesses to an exit end of the recesses. For recesses that bring in fluid in the boundary layer said angle is approximately 0° at the entry end and approximately 90° at the exit end. As a result thereof, the vortices exit the recesses in a different direction than said main fluid flow, in particularly approximately orthogonal to said main fluid flow, thereby influencing the main fluid flow continuously over more or less the entire surface of the layer, and thereby bringing in turbulent fluid into the boundary layer. For recesses that suck off turbulent fluid from the boundary layer said angle is approximately 90° at the entry end and approximately 0° at the exit end. It is noted that an angle at the exit end of 0° is preferred, but that this is difficult to realize in practice, thus, said angle at the exit end may be larger than 0°. As a result thereof, the vortices exit the recesses approximately parallel to the direction of said main fluid flow, are thereby discharged in the main fluid flow and become laminar at a distance of approximately 20-40 times the diameter of the vortices, thereby sucking turbulent fluid out of the boundary layer. Two vortices come together from both sides of the surface element and rotate in different directions, thereby maintaining stability.

Preferably, the transverse cross-section of each recess is substantially circular. In such a recess a vortex with a more or less circular cross-section is created.

In an embodiment of the layer according to the invention the diameter of each recess decreases near its end zones, in particular near its longitudinal end zones. Such a recess is particularly suitable for surface elements that suck off turbulence fluid, because this enhances the discharge of the vortices in the main fluid flow.

In an embodiment of the layer according to the invention, each outer surface comprises a pattern of alternating peaks and valleys extending longitudinally in the first direction. Such alternating peaks and valleys extending longitudinally in the first direction are also known as riblets, which are known to reduce drag. In accordance with the invention, the height of the top and/or the height of the bottom of the riblets with respect to the surface of the layer increases in the first direction.

In another embodiment of the layer according to the invention the height (h) of a peak with respect to a valley is between 0.5 and 0.7 the spacing (s) between two peaks.

In yet another embodiment of the layer according to the invention the height hₚ of the peaks reaches a maximum height at a first location upstream to an end of said element seen in the first direction, and wherein between said first location and said end said height hₚ of the peaks remains substantially said maximum height.

The applicant has found that such an outer surface provides an improved drag reduction as compared to an outer surface with peaks with an increasing height op to the end of the elements.

Preferably the height of the peaks gradually rises up to said maximum height at said first location. With gradually is meant here a more or less continuous inclination angle.

In another embodiment of the layer according to the invention, said elements have a substantially diamond shaped longitudinal cross section in the main plain of the elements, wherein two first end zones are substantially convex and two second end zones are substantially concave.

The convex end zones may start from or end in a similar point. Alternatively, the convex end zones may start or end at a certain distance b1 from each other. Said distance b1 may be n times smaller than the width of said element. For example, n may be less than 0.4, less than 0.2, less than 0.1, less than 0.05, or less than 0.02. The applicant has found that such a configuration may further reduce the fluid resistance.

In yet another embodiment of the layer according to the invention the elements are rotated incrementally in the plane of the layer with respect to the first direction between a maximum angle and a minimum angle. The applicant has found that such a configuration may further reduce the fluid resistance.

Said maximum angle is for example 10°, preferably 8°, more preferably 7° and said minimum angle is for example −10°, preferably −8°, more preferably −7°. The applicant has found that such maximum and minimum angles are suitable.

The incremental angle between two adjacent elements as seen in a direction orthogonal to the first direction is for example between −1° and 1°, preferably between −0.5° and 0.5°, even more preferably between −0.33° and 0.33°. The applicant has found that such an incremental angle is suitable.

In another preferred embodiment of the layer according to the invention, the quotient of the pitch distance in the first direction between adjacent surfaces and the desired cruising speed of the object is substantially 20-65 kHz for air. Due to the alternating changes in height between the different elements vibrations occur in the air which can possibly cause a sound. The generation of these vibrations likewise causes fluid resistance, which is undesirable. By now modifying the distance between the elements to the desired cruising speed of the object it is possible to select the created vibrations such that a minimum amount of energy is lost herein. It has been found that this energy consumption is minimal at a frequency of around 20-65 kHz.

In another embodiment of the layer according to the invention the layer is a foil.

In yet another embodiment of the layer according to the invention, the foil has a base layer made of polyvinylchloride (PVC) or a mixture of polyvinylchloride (PVC) and ethylene vinyl acetate (EVA), and a top layer made of polytetrafluoroethylene (PTFE), silicones, polyvinylidene fluoride (PVDF), or acrylate/polyvinylidene fluoride.

These and other features of the invention are further elucidated with reference to the accompanying drawing.

FIG. 1 shows a top view of a layer according to a first embodiment of the invention.

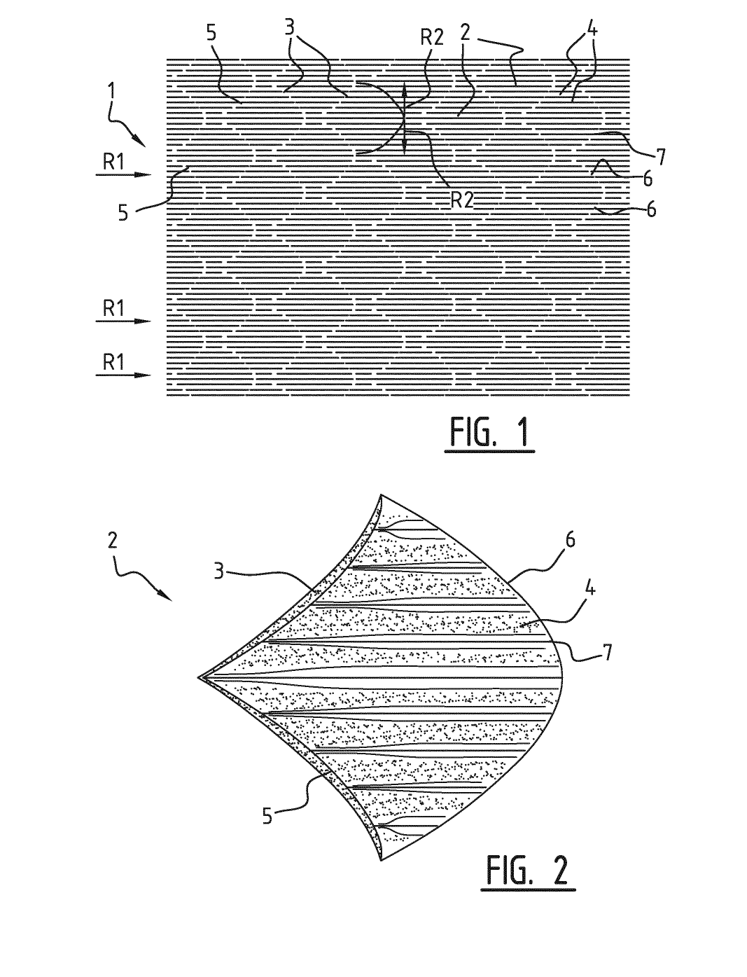

FIG. 2 shows a top view of one element of the layer of FIG. 1.

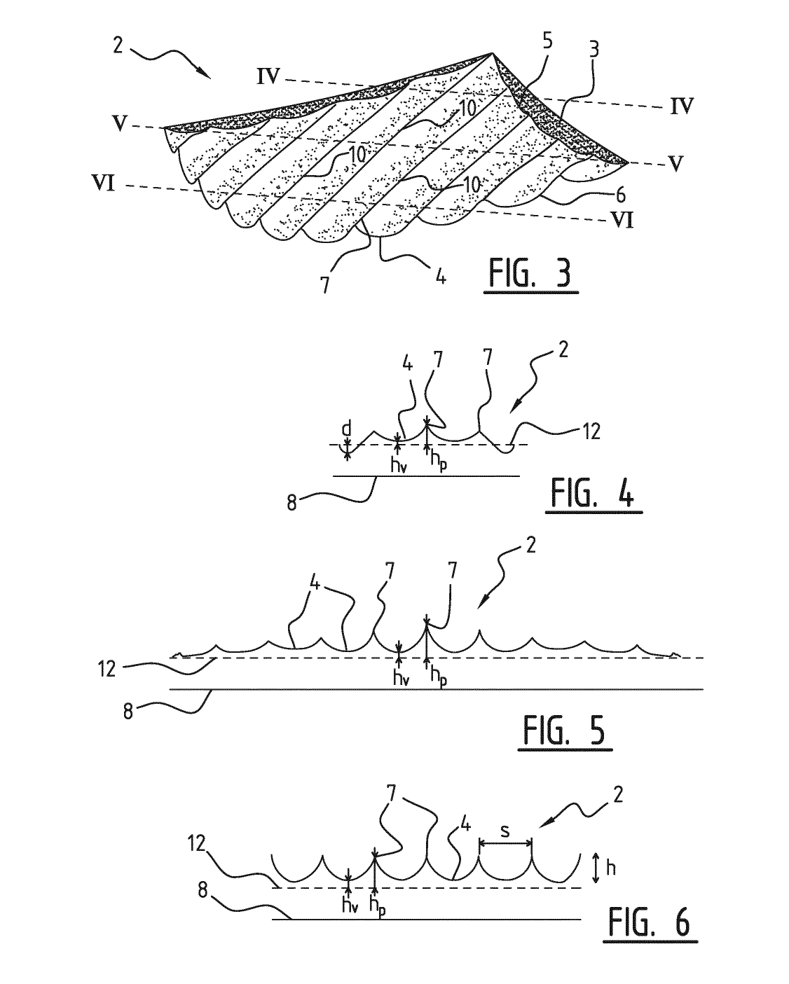

FIG. 3 shows a perspective view of the element of FIG. 2.

FIGS. 4-6 show transverse cross sections of the element of FIG. 3 at different locations.

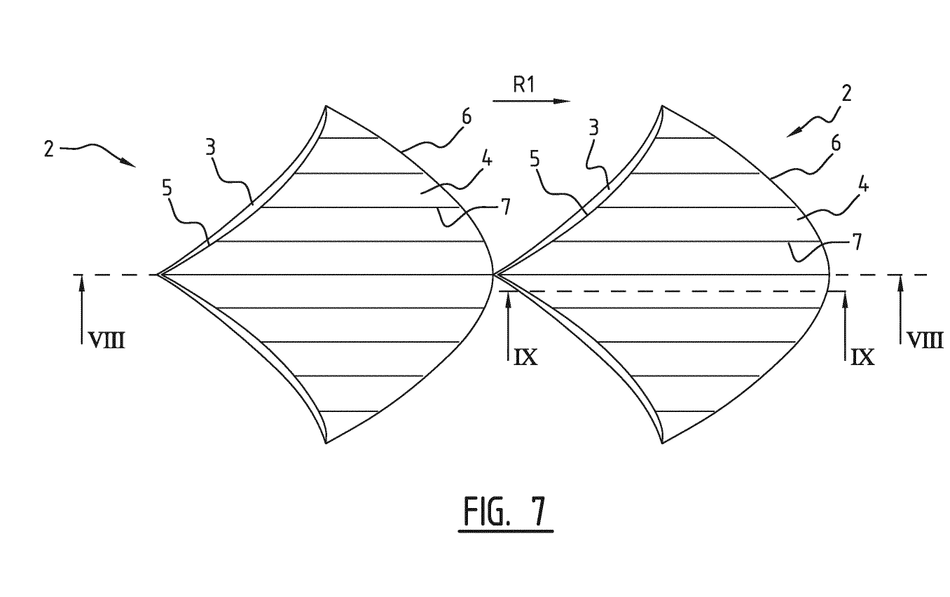

FIG. 7 shows a simplified top view of two elements of the layer of FIG. 1.

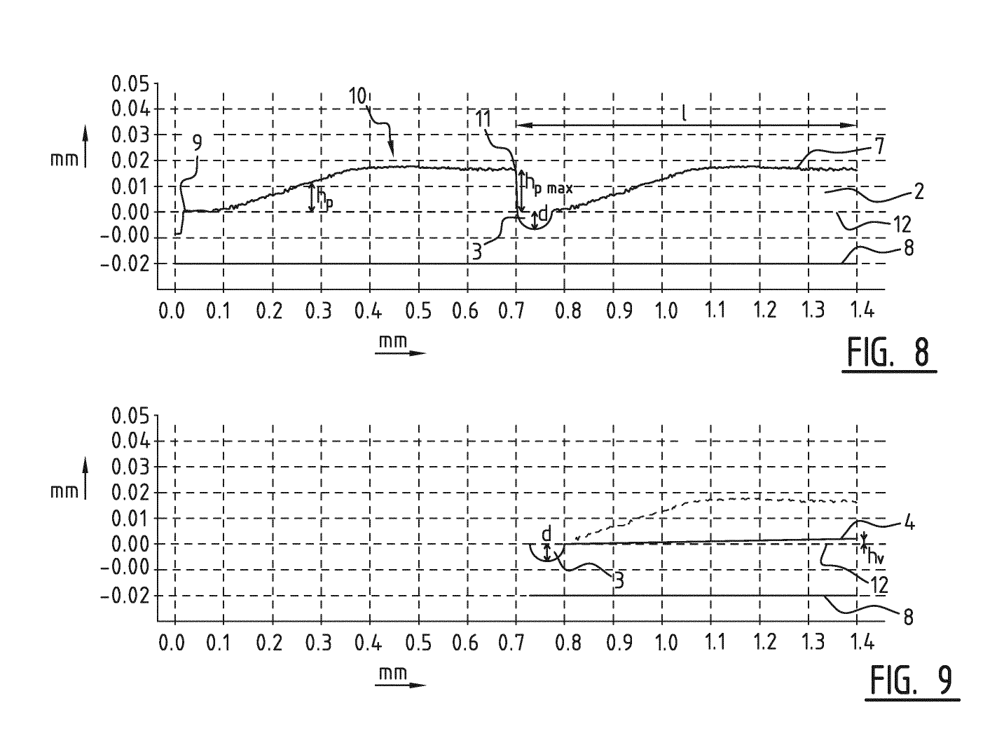

FIGS. 8 and 9 show a longitudinal cross section of the two elements of FIG. 7, wherein FIG. 8 is a cross section through a peak and FIG. 9 a cross section through a valley.

FIG. 10 shows a top view of a layer according to a second embodiment of the invention.

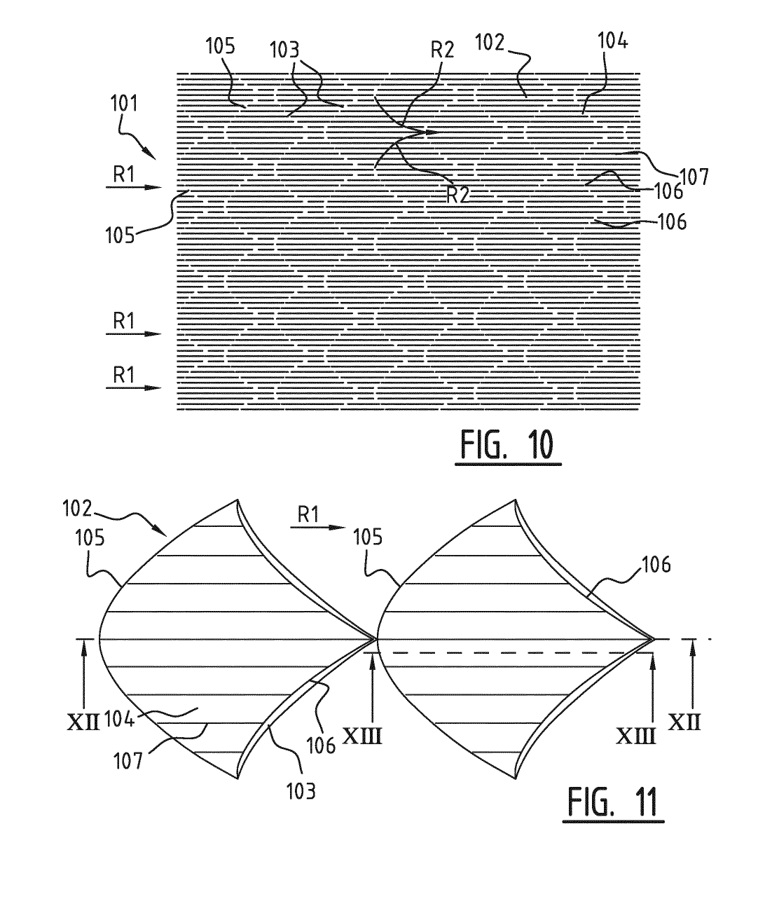

FIG. 11 shows a simplified top view of two elements of the layer of FIG. 10.

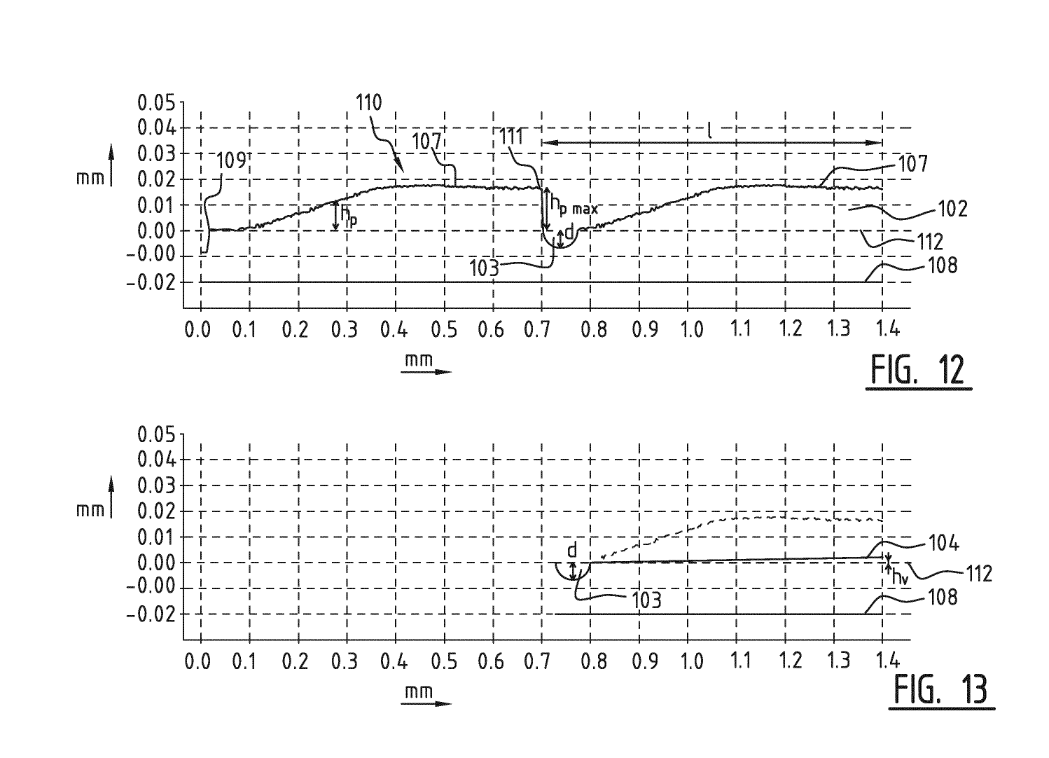

FIGS. 12 and 13 show a longitudinal cross section of the two elements of FIG. 11, wherein FIG. 12 is a cross section through a peak and FIG. 13 a cross section through a valley.

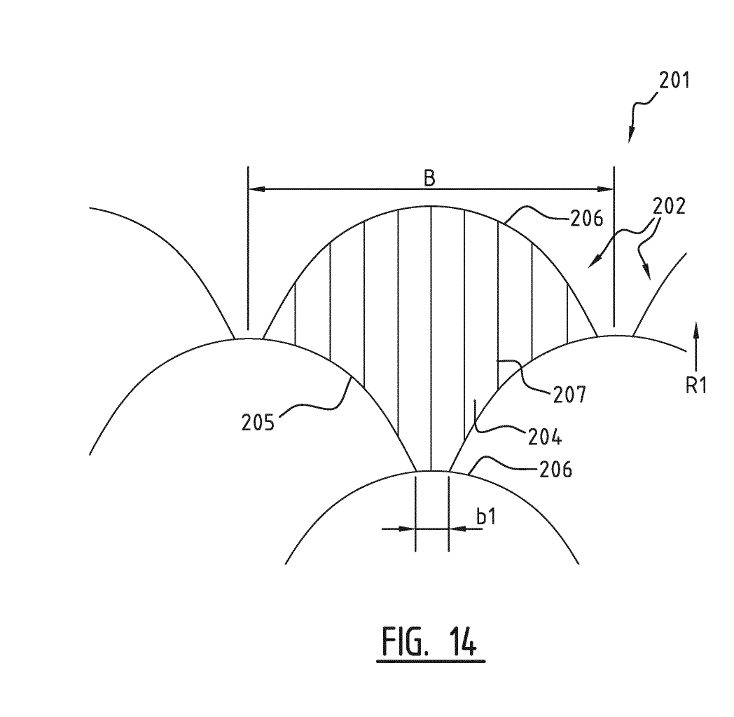

FIG. 14 shows a simplified top view of a layer according to a third embodiment of the invention.

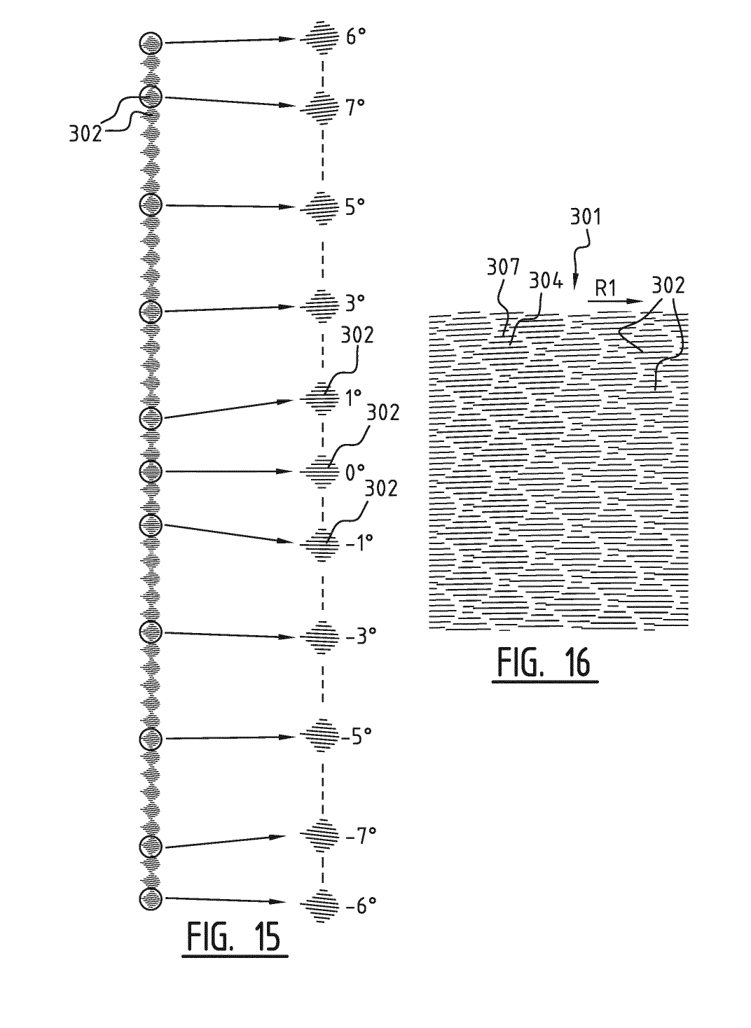

FIGS. 15 and 16 show a top view of a layer according to a fourth embodiment of the invention.

FIG. 1 shows a layer 1 for reducing fluid resistance between an object and a fluid that are moving with a relative mutual speed. As is shown in FIGS. 4-6 and 8, said layer 1 comprises a substantially planar surface 12, which surface 12 comprises a pattern of outwardly extending elements 2. FIGS. 4-6 show one element 2 and FIG. 8 shows two elements 2. As is clear from FIGS. 1-9, said elements 2 have an outer surface composed of peaks 7 and valleys 4, which peaks 7 and valleys 4 extend longitudinally in a first direction R1 in the plane of the layer 1. The direction R1 is also the main direction of the fluid flowing over the layer 1. The peaks 7 have a certain height hₚ with respect to the surface 12 of the layer 1, which certain height increases in a first direction R1, see also FIGS. 4-6 and 8. The valleys 4 have a certain height hᵥ with respect to the surface 12 of the layer 1, which certain height increases in a first direction R1, see also FIGS. 4-6 and 8. The surface 12 of the layer 1 further comprises a plurality of recesses 3 extending between the elements 2 in a second direction R2 in the plane of the layer. The recesses 3 have a certain depth d with respect to the surface 12 of the layer 1, see also FIGS. 4 and 8. The second direction R2 varies over the length of the recess and is approximately 0° with respect to the first direction R1 at the entry end of the recess 3 and approximately 90° with respect to the first direction R1 at the exit end of the recess 3, see also FIG. 1. Due to the direction of the vortices in the recesses 3 being orthogonal to the main direction of the fluid flow, said vortices influence the main fluid flow over more or less the entire width of the layer 1 and thereby bring turbulent fluid into the boundary layer.

The upper surface 12 and the surface elements 2 and recesses 3 may be formed as one integral part. As such, the planar surface 12 may not be visible from the outside, since the surface elements 2 and the recesses 3 form the outer surface of the layer 1. The upper surface 12 may also be seen as a theoretical base plane extending in the main plane of the layer 1, parallel to a lower surface 8 of the layer 1 at a certain distance there from, with respect to which base plane the height of the surface elements 2, in particular the height hₚ of the peaks 7 and the height hᵥ of the valleys 4, and the depth d of the recesses 3 are defined.

As is shown in FIGS. 1-3, the surface elements 2 have a substantially diamond shaped longitudinal cross section in the main plain of the elements, wherein the elements 2 have concave front edges 5 and convex rear edges 6, which convex rear edges 6 form one continuous edge. The surface elements 2 of layer 1 are hereby formed as approximately the scales of a fish. The recesses 3 have a longitudinal shape that is adapted to the concave front edges 5 and the convex rear edges 6, and thus the angle between the second direction R2 and the first direction R1 varies over the length of the recesses 3.

FIGS. 2 and 3 show one surface element 2 of the layer 1 of FIG. 4 in more detail. The lower located valleys 4 and the even lower located recesses 3 are herein shaded. The higher located peaks 7 are not shaded.

FIGS. 4-6 show a transverse cross section perpendicular to the main plane of the surface element 2 of FIG. 3 at three different longitudinal positions in the first direction R1. From these figures it is clear, see also FIG. 8, that each peak 7 starts rising from its start longitudinal position 9, gradually rises up to a maximum height hₚₘₐₓ at a second longitudinal position 10, and then maintains the same maximum height hₚₘₐₓ up to the end of the element 2. With respect to the middle peak 7, the other peaks 7, which are located on both transverse sides of the middle peak 7, have a start longitudinal position and a second longitudinal position that are located downstream of the start longitudinal position and the second longitudinal position of the middle peak. As such, the heights hₚ of the other peaks 7 are lower than the height hₚ of the middle peak 7 at the same longitudinal positions as shown in FIGS. 4 and 5. At the downstream longitudinal position as shown in FIG. 6 the height hₚ of all the peaks 7 is more or less the same. As is also clear from FIGS. 4-6, the peaks 7 are relatively small and sharp.

As is further shown in FIGS. 4-6, the valleys 4 rise more or less continuously, such that the height hᵥ of the valleys 4 also increases more or less continuously in the first direction R1. The valleys 4 rise less than the peaks 7, such that the distance between the peaks 7 and valleys 4 increase in the first longitudinal direction R1.

FIG. 7 shows two surface elements 2, which are positioned adjacent to each other in the first longitudinal direction R1.

FIG. 8 shows a central longitudinal cross section transverse to the main plane of the two surface elements 2 of FIG. 7, which cross section crosses through the recesses 3 and through the middle peaks 7. From this figure it is clear, that recess 3 has a more or less circular transverse cross section. The depth d of the recess 3 is therefore more or less equal to the radius of the recess 3. A steep transition from the peak 7 to the lower level of the recess 3 occurs at the end of the peak 7 at longitudinal end position 11 in the transition area to the next surface element 2. It is clear from this FIG. 8, that the recess 3 is arranged lower than the valley 4. FIG. 8 further shows the lower end surface 8 of the layer 1, which runs parallel to the upper surface 12 at a certain distance thereof. The increasing height hₚ of the middle peak 7 is described above with respect to FIGS. 4-6.

FIG. 9 shows a central longitudinal cross section transverse to the main plane of the right hand side element 2 of FIG. 7, which cross section crosses through the recesses 3 and through the valley 4 located next to the middle peak 7. It is clear from this FIG. 9, that the recess 3 is arranged lower than the valley 4. The height hᵥ of the valley 4 increases continuously over the length of the element 2 and is at the end of the element 2 approximately 10-20% of the diameter or width of the recess 3.

FIG. 10 shows two a layer 101 according to a second embodiment of the invention. Similar elements are denoted by similar numbers increased by 100. Only the differences between the two layers 101 and 1 will be described below. For a further description of the layer 101 a reference is made to the description of FIGS. 1-9 above.

Said layer 101 differs from layer 1 of FIG. 1 in the surface elements 102 have convex front edges 105 and concave rear edges 106. The convex front edges 105 form one continuous front edge 105. The recesses extend in a second direction R2, which direction R2 varies over the length of the recesses 103. At an entry end of the recesses 103 the second direction R2 is approximately 90° with respect to the first direction and the exit end of the recesses 103 the direction R2 is close to being parallel to the first direction R1. As a result thereof, the vortices flow approximately parallel to the direction of said main fluid flow at the exit end of the recesses, are thereby discharged in the main fluid flow and become laminar at a distance of approximately 20-40 times the diameter of the vortices, thereby sucking turbulent fluid out of the boundary layer. The two vortices of the two recesses 103 surrounding one surface element 102 come together at the exit end an due to their opposing direction of rotation maintain stability as a vortex pair. It is noted that a recess 103 that has an exit end that is parallel to the main flow direction R1 is preferred, but that this is difficult to obtain in practice. Thus, the angle of the exit end of the recess and the first direction R1 may be larger than 0°, as is also shown in FIG. 11.

FIG. 11 shows two surface elements 102, which are positioned adjacent to each other in the first longitudinal direction R1. The width of the recesses 103 decreases near the ends of the recesses 103. In particular, the width of the recesses in the middle of the recesses 103 seen in the longitudinal direction may be 20-50% larger than the width of the recesses 103 near the ends. As a result of the decreasing width near the exit end of the recesses 103, the discharge of the vortices in the main flow is enhanced.

FIG. 12 shows a central longitudinal cross section transverse to the main plane of the two surface elements 102 of FIG. 11, which cross section crosses through the recesses 103 and through the middle peaks 107. This cross section is more or less similar to the cross section of FIG. 8, which shows that the surface elements 102 rise according to a similar pattern. Thus, a reference to FIG. 8 is made for a description thereof.

FIG. 13 shows a central longitudinal cross section transverse to the main plane of the right hand side element 102 of FIG. 11, which cross section crosses through the recesses 103 and through the valley 104 located next to the middle peak 107. This cross section is more or less similar to the cross section of FIG. 9, which shows that the surface elements 102 rise according to a similar pattern. Thus, a reference to FIG. 9 is made for a description thereof.

The dimensions of the tops 7, 107, valleys 4, 104 and recesses 3, 103 may be chosen in dependency of various parameters, such as, but not limited thereto, the type of fluid, in particular the density and the (kinematic) viscosity, and the velocity of the fluid flow or the velocity of the object. For example, the height (h) of a peak, defined with respect to the valley, see FIG. 6, is between 20-500 μm, the spacing (s) is between 40-1000 μm and the depth (d) is between 5-100 μm. In particular h is between 0.5*s and 0.7*s.

FIG. 14 shows a layer 201 according to a third embodiment of the invention. Similar elements are denoted by similar numbers increased by 200 with respect to the first embodiment and increased by 100 with respect to the second embodiment. Only the differences of the layer 201 with respect to the layers 1, 101 according to the first and second embodiment will be described below. For a further description of the layer 201 a reference is made to the description of FIGS. 1-14 above.

The layer 201 differs from the layers 1, 101 in that the concave front edges 205 of a surface element 202 of the layer 201 do not start from one similar point. Instead, the concave front edges 205 start at a distance b1 from each other, each from a different point of a previous element 202. A part of the convex rear edge 206 of one surface element 202 thus extends between the two front edges 205 of a next surface element 202. The distance b1 is smaller than the maximum width B of a surface element 202. In particular, the distance b1 may be less than 0.4*B, less then 0.2*B, less then 0.1*B, less then 0.05*B, less then 0.02*B, or even smaller.

It is noted that the third embodiment of the layer may be similar as the second embodiment, such that the direction R1 is reversed, and such that the rear edges of the surface element 202 are concave and the front edge are convex. In that case the concave rear edges do not end in one similar point. Instead, the concave rear edges end at a distance b1 from each other, each at a different point of a next element 202. A part of the convex front edge of one surface element 202 thus extends between the two rear edges of a previous surface element 202. The distance b1 is smaller than the maximum width B of a surface element 202. In particular, the distance b1 may be less than 0.4*B, less then 0.2*B, less then 0.1*B, less then 0.05*B, less then 0.02*B, or even smaller.

FIGS. 15 and 16 show a layer 301 according to a fourth embodiment of the invention. Similar elements are denoted by similar numbers increased by 300. Only the differences between the two layers 301 and 1 will be described below. For a further description of the layer 301 a reference is made to the description of FIGS. 1-9 above.

As is shown in FIGS. 15 and 16 the elements 302 are rotated incrementally in the plane of the layer 301 with respect to the first direction R1 between a maximum angle of +7° and a minimum angle of −7°. The increasing or decreasing incremental angle between two neighboring elements 302 is calculated by dividing the difference between the maximum and minimum angle by the number of elements 302 that are rotated there between. In this example, 42 elements 302 are rotated from +7° to −7° or vice versa, thus each incremental angle is −0.33° or +0.33°. After reaching the maximum angle of +7° or minimum angle of −7° the next neighboring element 302 will start rotating in opposite direction, thereby going back to a rotation of −7° or +7° respectively in incremental steps. In such a configuration of the layer 301 a wake is created, thereby further introducing turbulent fluid into the main fluid flow.

The maximum angle of +7° and the minimum angle of −7° may be suitably chosen. The applicant has found, that a small maximum or minimum angle, for example maximum +8° and minimum −8°, is suitable. The number of elements 302 between the minimum and maximum angle may also be suitably chosen. As described above, the incremental angle is defined by the difference between this maximum and minimum angle and the number of elements there between.

When layer 1, 101, 201, or 301 according to the invention is arranged on a vehicle, for instance a car, an airplane, or a boat, the pitch distance of the surfaces and the orientation thereof can then be adapted to the fluid flow over the surface of the car. Various aspects can thus be further optimized in order to obtain the lowest possible fluid resistance. The power of the engine is hereby utilized better, and this power can be used either to obtain a lower fuel consumption or a higher top speed.

When layer 1, 101, 201, or 301 according to the invention is arranged on a standing object, for example on the inner surface of a fluid pipe, for example for transporting oil, the friction of the moving fluid with respect to the standing object is reduced.

1. Layer for reducing fluid resistance between an object and a fluid that are moving with a relative mutual speed, said layer comprising a substantially planar surface, said surface comprising a pattern of outwardly extending elements, said elements having an outer surface with a certain height with respect to the surface of the layer, said certain height increasing in a first direction in the plane of the layer, wherein the surface of the layer further comprises a plurality of recesses extending between the elements in a second direction in the plane of the layer, which recesses have a certain depth with respect to the surface of the layer.

2. Layer as claimed in claim 1, wherein the cross-section of each recess is substantially circular.

3. Layer as claimed in claim 2, wherein the diameter of each recess decreases near its end zones.

4. Layer as claimed in claim 1, wherein each outer surface comprises a pattern of peaks and valleys extending in the first direction.

5. Layer as claimed in claim 4, wherein the height hₚ of the peaks and/or the height hᵥ of the valleys with respect to the surface of the layer increases in the first direction.

6. Layer as claimed in claim 4, wherein the height (h) of a peak with respect to a valley is between 0.5 and 0.7 the spacing (s) between two peaks.

7. Layer as claimed in claim 4, wherein the height hₚ of the peaks reaches a maximum height at a first location upstream to an end of said element seen in the first direction, and wherein between said first location and said end said height hₚ of the peaks remains substantially said maximum height.

8. Layer as claimed in claim 7, wherein the height hₚ of the peaks gradually rises up to said maximum height at said first location.

9. Layer as claimed in claim 1, wherein said elements have a substantially diamond shaped longitudinal cross section in the main plain of the elements, wherein two first end zones are substantially convex and two second end zones are substantially concave.

10. Layer as claimed in claim 9, wherein the convex end zones start from or end in a similar point.

11. Layer as claimed in claim 9, wherein the convex end zones start or end at a certain distance b1 from each other.

12. Layer as claimed in claim 11, wherein said distance b1 is n times smaller than the width of said element.

13. Layer as claimed in claim 12, wherein n is less than 0.4, less than 0.2, less than 0.1, less than 0.05, or less than 0.02.

14. Layer as claimed in claim 1, wherein the layer is a foil.

15. Layer as claimed in claim 14, wherein the foil has a base layer made of polyvinylchloride (PVC) or a mixture of polyvinylchloride (PVC) and ethylene vinyl acetate (EVA), and a top layer made of polytetrafluoroethylene (PTFE), silicones, polyvinylidene fluoride (PVDF), or acrylate/polyvinylidene fluoride.

16. Layer as claimed in claim 1, wherein the elements are rotated incrementally in the plane of the layer with respect to the first direction between a maximum angle and a minimum angle.

17. Layer as claimed in claim 16, wherein said maximum angle is 10°, preferably 8°, more preferably 7° and wherein said minimum angle is −10°, preferably −8°, more preferably −7°.

18. Layer as claimed in claim 16, wherein an incremental angle between two adjacent elements as seen in a direction orthogonal to the first direction is between −1° and 1°, preferably between −0.5° and 0.5°, even more preferably between −0.33° and 0.33°.
